(19) United States
(12) Patent Application Publication
(10) Pub. No.: US 2011/0265290 A1
(43) Pub. Date: Nov. 3, 2011

(54) Universal cable clamp

(76) Inventor: Jeffrey D. Carnevali, Seattle, WA (US)

(21) Appl. No.: 12/799,658

(22) Filed: Apr. 28, 2010

(51) Int. Cl. F16B 2/08

(52) U.S. Cl. 24/326

(57) ABSTRACT

A cable-based universal clamping device having a contoured base structured for stability on a diverse variety of differently contoured mounting surfaces, and a strong and flexible cable for securing to a variety of platforms having a diverse variety of nonspecific shapes and sizes. A hollow drum extends above the contoured base with a slot or port that communicates between the hollow interior and an outer surface of the drum. A ramp travels over the drum's outer surface from the port toward the base. The clamp includes a spool that is rotatable inside the cylindrical hollow interior of the drum. The cable has one end fixed to the spool and its length is wound about the spool. The cable exits from the drum through the slot or port and includes an anchor that is interlockable with an anchor receiver on the clamp.

### FIELD OF THE INVENTION

The present invention relates generally to clamping devices, and in particular to clamping devices having a manually retractable cable wrap member.

### BACKGROUND OF THE INVENTION

Clamping devices for mounting on external platforms are generally well-known. However, known clamping devices are generally limited to mounting on a platform of specific size and shape. Some known clamping devices have universal clamping means structured for clamping a mount body to platforms of nonspecific shape and/or size.

However, known universal clamping devices tend toward complex and awkward clamping means and are limited in ability to efficiently provide quick and reliable clamping.

### SUMMARY OF THE INVENTION

The present invention is a cable-based universal clamping device having a contoured base structured for stability on a diverse variety of differently contoured mounting surfaces, and a strong and flexible cable of a desirable length for securing the contoured base to a variety of platforms having a diverse variety of nonspecific shapes and sizes. A hollow drum extends above the contoured base with a slot or port that communicates between the hollow interior and an outer surface of the drum. A ramp travels over the drum's outer surface from the port toward the base.

The clamp includes a spool that is rotatable inside the cylindrical hollow interior of the drum. The cable has one end fixed to the spool and its length is wound about the spool. The cable exits from the drum through the slot or port and includes an anchor adjacent to its opposite end.

For clamping, the contoured base is fit against a surface of a target platform with the cable unwound from the spool through the port. The strong but flexible cable is led along the ramp and across the base before being wrapped around a portion of the target platform. The cable is brought back across the base and threaded through a sturdy anchor receiver on an opposite side of the drum. Thereafter, the spool is rotated within the drum to draw the cable back through the port into the drum, pulling the cable tight about the target platform with the contoured base firmly seated against the platform surface. When the cable is sufficiently retracted into the drum to secure the clamping device on the target platform, the spool is locked in place against spinning within the drum and releasing the tension on the cable. For example, a pawl or detent such as spring operated hinged catch, dog or ball is formed between the drum and the spool. Optionally, the pawl or detent is constructed as a ratch that permits the spool to rotate in only one direction that tightens the tension on the cable.

According to one aspect of the universal clamping device, the contoured base is optionally formed with guide features that position the flexible cable relative to the base for effectively stabilizing the clamping device relative the target platform. The guide features are optionally numbered for guiding the user in winding the flexible cable along the most effective path for securing the clamping device on the target platform. Of course, other paths may be used and may be more effective for securing the clamping device on different target platforms.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the novel cable-based universal clamping device;

FIGS. 2 and 3 are two view of the same universal clamping device illustrated in FIG. 1, wherein FIG. 2 illustrates one side of the same clamping device shown in FIG. 1 being clamped to a substantially cylindrical target platform with a V-contoured interior seating surface on its saddle-shaped base being clamped against a substantially round platform surface, and

FIG. 3 illustrates a different side of the same clamping device shown in FIGS. 1 and 2 being clamped to a contoured surfaces of one of a variety of target platforms having a diverse variety of nonspecific shapes and sizes;

FIG. 4 and FIG. 5 are two different views of the same universal clamping device illustrated in FIGS. 1, 2 and 3 being mounted on a contoured surface of a target platform, wherein FIG. 4 is a top view looking down at a mount projected above the base, and FIG. 5 is a bottom view looking up at the target platform and the contoured interior seating surface on the saddle portion of the base;

FIG. 6 and FIG. 7 are cross-section views illustrating operation of the same universal clamping device illustrated in FIGS. 1-5, wherein FIG. 6 illustrates the clamping device being configured for extraction of a flexible cable, and FIG. 7 illustrates the clamping device being configured for resisting extraction of the flexible cable;

FIG. 8 is a cross-section view illustrating exemplary details of construction of the same universal clamping device illustrated in FIGS. 1-7;

FIG. 9 illustrates one exemplary embodiment of a spool element of the same universal clamping device illustrated in FIGS. 1-8; and

FIG. 10 and FIG. 11 are cross-section views illustrating alternative exemplary details of construction of the same universal clamping device illustrated in FIGS. 1-9, wherein FIG. 10 illustrates the clamping device being configured for extraction of a flexible cable, and FIG. 11 illustrates the clamping device being configured for resisting extraction of the flexible cable.

### DETAILED DESCRIPTION OF PREFERRED EMBODIMENT

In the Figures, like numerals indicate like elements.

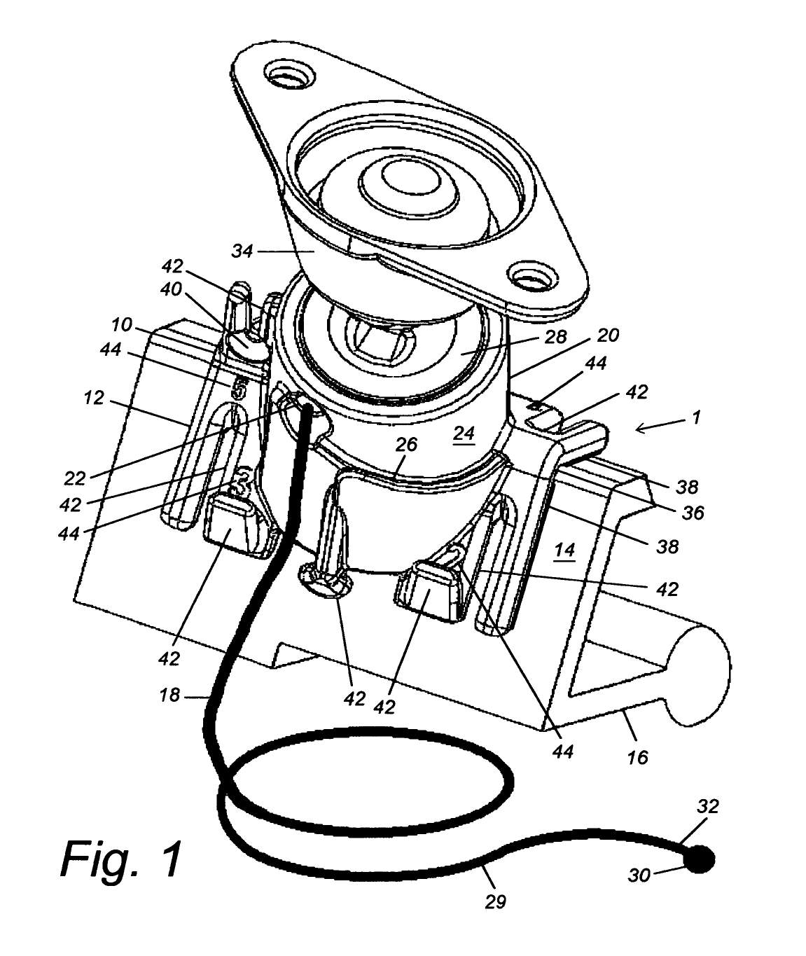

FIG. 1 illustrates a novel cable-based universal clamping device 10 formed of a rigid body 11 having a base flange 12 formed as a contoured saddle that is structured for stability on a diverse variety of differently contoured surfaces 14. As illustrated, contour of base flange 12 permits mounting on one of a variety of platforms 16 having a diverse variety of nonspecific shapes and sizes and even variable cross-section (shown). A strong and flexible cord or metallic wire cable 18 of desirable length is provided for securing base 12 to surface 14 of nonspecific platform 16. A hollow drum 20 extends above base 12 with an opening 22 such as a slot or port that communicates between a cylindrical hollow interior and an outer surface 24 of drum 20. A guide ramp 26 travels over outer surface 24 of drum 20 from port opening 22 toward base 12. Clamp 10 includes a spool 28 that is rotatable inside the cylindrical hollow interior of drum 20. Flexible cable 18 has a bitter end fixed to spool 28 and its length of working part 29 is wound about spool 28 within drum 20. Cable 18 exits from drum 20 through port opening 22 and includes an anchor 30 adjacent to its opposite working end 32. Any mount 34 is projected from drum 20 on one end of spool 28. Mount 34 is any of a variety of different mounts such as but not limited to a ball-and-socket of the type illustrated here.

A contoured interior seating surface 36 on base flange saddle 12 optionally includes a friction finish 38. For example, friction finish 38 is a knurled surface formed on interior mounting surface 36. Alternatively, friction finish 38 is a protective silicone or other rubberized coating or pad on interior mounting surface 36 that both increases friction at the interface between mounting surface 36 and surface 14 of target platform 16 and protects platform surface 14 from marring. Flex cable 18 also may be coated to protect against marring surface 14 of target platform 16.

For mounting of universal clamping device 10, contoured interior seating surface 36 of base 12 is fit against any surface 14 of target platform 16 with flex able 18 unwound from spool 28 through port opening 22. The strong but flexible cable 18 is led along guide ramp 26 and across base 12 before being wrapped around a portion of target platform 16. Cable 18 is brought back across base 12 and threaded through a sturdy anchor receiver 40 on an opposite side of drum 20 from guide ramp 26. Thereafter, spool 28 is rotated within drum 20 to draw cable 18 back through port opening 22 into drum 20, pulling cable 18 tight about target platform 16 with contoured seating surface 36 of base 12 firmly seated against target platform surface 14. When cable 18 is sufficiently retracted into drum 20 to secure clamping device 10 on target platform 16, spool 28 is locked in place against spinning within drum 20 and releasing the tension on cable 18. For example, a pawl and detent interference mechanism is formed between drum 20 and spool 28. Optionally, the pawl and detent mechanism is constructed as a ratch that permits spool 28 to rotate in only one direction relative to drum 20 that tightens the tension on cable 18.

Optionally, contoured base 21 is formed with one or more different guide features 42 that position flexible cable 18 relative to base 12 for effectively stabilizing clamping device 10 relative target platform 16. Sequential characters 44 such as numbers are optionally associated with guide features 42 for guiding the user in winding flexible cable 18 along an effective path for securing clamping device 10 on target platform 16. Of course, other paths may be used and may be more effective for securing clamping device 10 on different target platforms.

Clamping device 10 is illustrated clamped to different target platforms.

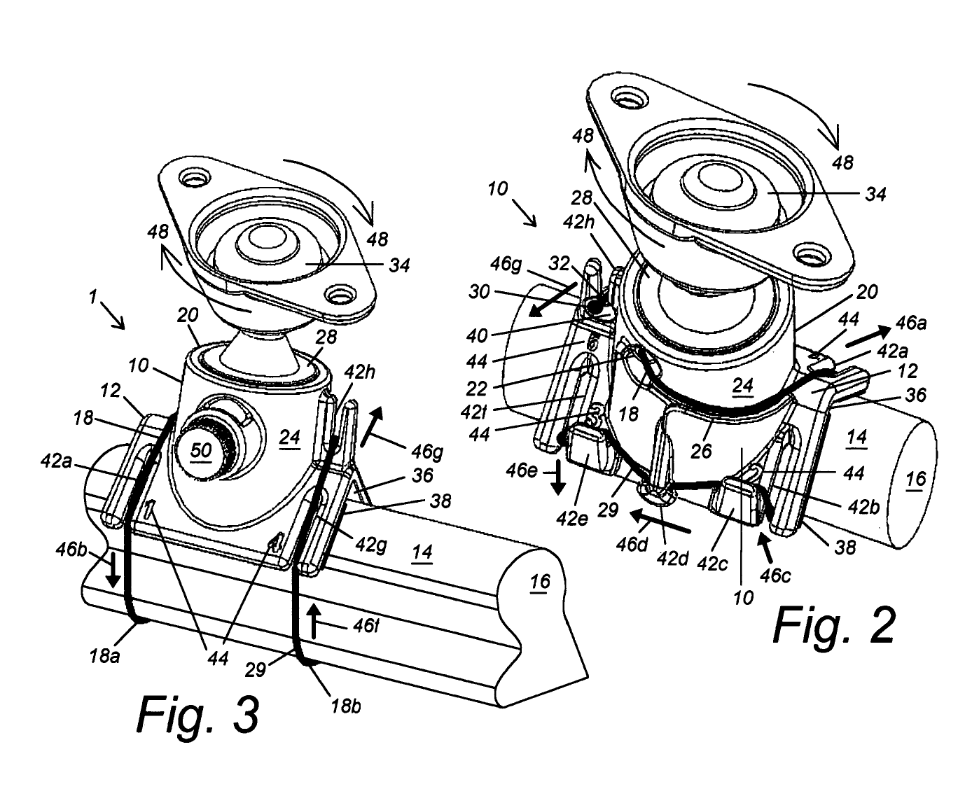

FIG. 2 illustrates clamping device 10 is illustrated clamped to target platform 16 of substantially cylindrical shape with V-contoured interior seating surface 36 on of base flange 12 clamped against substantially round platform surface 14. Flex cable 18 exits drum 20 through port opening 22 and is led along guide ramp 26 and across base 12 through one guide feature 42a (arrow 46a). As illustrated in FIG. 3, flex cable 18 is led from guide feature 42a for a first wrap 18a around target platform 16 (arrow 46b). As illustrated in FIG. 2, after wrapping around a portion of cylindrical target platform 16, cable 18 is brought back to base 12 and threaded through another guide feature 42b (arrow 46c). One end portion of base 12 on one end of drum 20 is thus prepared for clamping against target platform 16. Next, flex cable 18 is threaded through one or more additional guide features 42c, 42d, 42e (arrow 46d) along one side of drum 20 for transferring flex cable 18 to the other end portion of base 12 on an opposite end of drum 20 in a stabilizing manner. Flex cable 18 is led through another guide feature 42f (arrow 46e) adjacent to the other end portion of base 12 for a second wrap 18b around cylindrical target platform 16.

As illustrated in FIG. 3, flex cable 18 is led across surface 14 of target platform 16 and through another guide feature 42g (arrow 460 at an opposite end of base 12 from guide features 42a, 42b. Flex cable 18 crosses back over contoured base 12 and through a final guide feature 42h (arrow 46g).

As illustrated in FIG. 2, after first and second wraps 18a, 18b of flex cable 18 around target platform 16, anchor 30 is finally seated with anchor receiver 40 on an opposite side of drum 20 from guide ramp 26. Thereafter, spool 28 is rotated (arrows 48) within drum 20 to compress contoured seating surface 36 of base flange 12 against surface 14 of target platform 16 by drawing cable 18 back through port opening 22 into drum 20. Flex cable 18 is thereby tightened about target platform 16 with contoured interior seating surface 36 of base flange 12 firmly seated against target platform surface 14. When cable 18 is sufficiently retracted into drum 20 to secure clamping device 10 on target platform 16, spool 28 is locked in place against spinning within drum 20 and releasing the tension on cable 18. For example, a knob 50 operates an interference mechanism between drum 20 and spool 28. For example, the interference mechanism is a pawl, such as spring operated hinged catch, dog or ball, that is moveable relative to a detent. Optionally, the pawl-and-detent interference mechanism is constructed as a ratchet that permits spool 28 to rotate in only one direction relative to drum 20 that tightens the tension on cable 18.

Friction finish 38 provides additional frictional gripping at interface between contoured interior mounting surface 36 of base flange 12 and contoured surface 14 of target platform 16.

As illustrated in FIG. 2, guide features 42 in base flange 12 permit target platform 16 to be significantly smaller than base flange 12. Reentrant guide features 42 extend deeply into base flange 12 which permits cable 18 to cinch base flange 12 against forms much smaller than itself.

FIG. 3 illustrates that flexibility of flex cable 18 permits base flange 12 to be firmly seated on a diverse variety of differently contoured surfaces 14 of a variety of target platforms 16 having a diverse variety of nonspecific shapes and sizes.

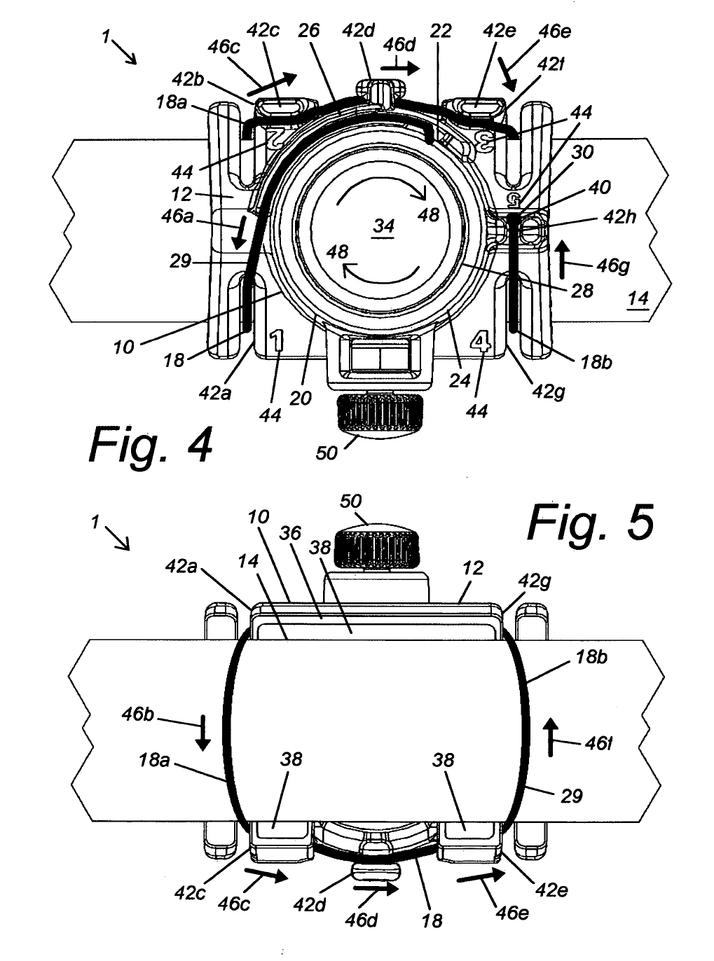

FIG. 4 and FIG. 5 are two views of universal clamping device 10 mounted on contoured surface 14 of target platform 16, wherein FIG. 4 is a top view looking down at mount 34 projected from drum 20 on one end of spool 28, and FIG. 5 is a bottom view looking up at target platform 16 and contoured interior seating surface 36 of base flange 12. As illustrated here and described herein in regard to FIGS. 2 and 3, flex cable 18 is threaded through multiple guide features 42, and first and second wraps 18a, 18b of flex cable 18 are made completely around target platform 16 before anchor 30 is finally seated with anchor receiver 40 on an opposite side of drum 20 from guide ramp 26. With contoured interior seating surface 36 of base flange 12 firmly seated against target platform surface 14, flex cable 18 is tightened about target platform 16 by rotation (arrows 48) of spool 28 within drum 20. Knob 50 operates an interference mechanism between drum 20 and spool 28 to maintain tension on cable 18. Friction finish 38 on interior mounting surface 36 grips contoured surface 14 of target platform 16 for stabilizing position of clamping device 10 on target platform 16.

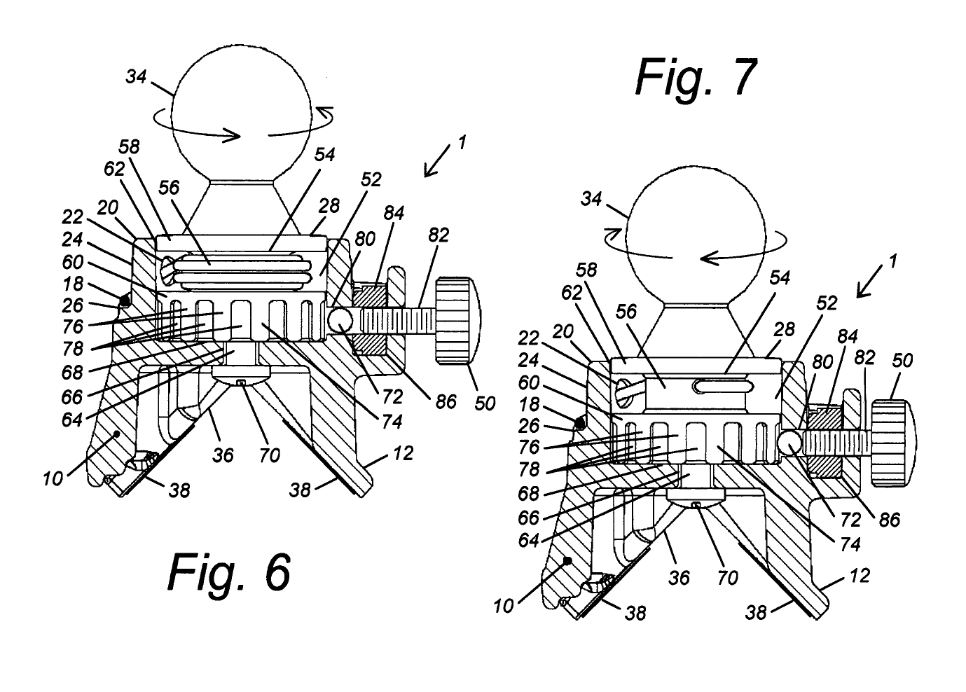

FIG. 6 and FIG. 7 are cross-section views of clamping device 10 illustrating operation of spool 28 within an open cylindrical hollow interior 52 of drum 20. FIG. 6 illustrates spool 28 being free to rotate within interior 52 of drum 20 for initial extraction of flex cable 18 or retraction thereof for cinching contoured interior seating surface 36 of base flange 12 against surface 14 of target platform 16. Base flange 12 is shown with friction finish 38 configured as a pad adhered to interior seating surface 36.

Spool 28 is illustrated as having a cylindrical core 54 having working part 29 of flex cable 18 coiled thereabout with an end of cable 18 exiting from drum 20 through port opening 22.

Cylindrical core 54 of spool 28 is formed with round rims or ridges 58 and 60 at each end. Mount 34 is projected from upper rim 58 of spool 28 opposite from its cylindrical core 54. Upper and lower rims 58, 60 of spool 28 are dimensioned to pass through an opening 62 into cylindrical interior 52 of drum 20 and fit rotatably therein. Spool 28 is rotatable within cylindrical hollow interior 52 of drum 20 on a spindle 64 sized to rotate in a hole 66 in a floor 68 of drum 20. Optionally, spindle 64 also operates to retain spool 28 in interior 52 of drum 20. For example, spindle 64 includes a head 70 that is positioned on an opposite side of drum floor 68 from spool 28 and is sized larger than hole 66 in floor 68 so as to retain spool 28 in drum interior 52 by not passing through hole 66. By example and without limitation, spindle 64 is a shoulder screw threaded into spool 28 through hole 66 in drum floor 68.

Means are provided for retaining tension thereon when flex cable 18 is operated to cinch contoured base flange 12 against surface 14 of target platform 16. Such means for retaining tension of cable 18 includes but is not limited to temporarily fixing spool 28 in place relative to drum 20, which resists spinning of spool 28 within drum 20. According to one embodiment, an interference mechanism includes a pawl 72 such as hinged catch, dog or spherical ball (as shown) that is releasably engageable between drum 20 and lower rim 60 of spool 28, which engagement temporarily fixes spool 28 against rotating in drum interior 52 until pawl 72 is released. For example, the entire circumference 74 of lower rim 60 of spool 28 is formed thereabout with a plurality of teeth 76 defined a plurality of circumferential detents 78 formed as indentations interrupting circumference 74.

According to one embodiment, pawl 72 is movable in a bore 80 and operated by knob 50. In one manually operated interference mechanism, knob 50 is coupled to threaded shaft 82 and is mated to an internal thread 84 aligned with detent bore 80. For example, a nut pocket 86 is molded externally of drum 20 adjacent to detent bore 80, and internal thread 84 is a nut fit into nut pocket 86 and mated to threaded shaft 82. Turning threaded shaft 82 into threaded nut 84 drives ball 72 against lower rim 60 of spool 28. Ball 72 fits into one of circumferential detents 78 between teeth 76. Interference between ball 72 and teeth 76 temporarily fixes spool 28 against rotating in drum interior 52 until ball 72 is disengaged. Ball 72 thus prevents spool 28 from spinning within interior 52 of drum 20 and releasing the tension on cable 18.

Alternatively, operation of knob 50 drives tip of threaded shaft 82 into direct contact with lower rim 60 of spool 28, without ball 72 therebetween. However, catch, dog or spherical ball-type pawl 72 is optionally made of a softer material, such as but not limited to nylon or plastic, such that lower rim 60 of spool 28 is not damaged by contact therewith.

In operation, knob 50 is operated to back threaded shaft 82 away from spool 28 in drum 20 by turning relative to internal thread 84. Ball 72 is thus freed in bore 80 and disengaged (shown) from detents 78 between teeth 76 in lower rim 60 of spool 28 whereby spool 28 spins freely inside hollow interior 52 of drum 20. Flex cable 18 is unwound from spool core 54 (arrow) and wrapped around outer surface 24 of drum 20 along guide ramp 26 as disclosed herein.

FIG. 7 illustrates working part 29 of flex cable 18 mostly unwound from cylindrical core 54 from spool 28 and exiting from drum 20 through port opening 22. For example, flex cable 18 is led along guide ramp 26 formed about outer surface 24 of drum 20 and working part 29 is wrapped around target platform 16 with contoured interior seating surface 36 of base flange 12 seated against surface 14, as disclosed herein. Seating surface 36 of base 12 is cinched against target platform surface 14 by twisting (arrows) spool 28 on spindle 64 inside hollow interior 52 of drum 20, which tensions flex cable 18. When base flange 12 is cinched sufficiently snug against target platform surface 14, ball 72 is engaged (shown) with adjacent detent 78 between teeth 76 in lower rim 60 of spool 28 whereby spool 28 is temporarily fixed against rotating in drum interior 52 until ball 72 is disengaged. For example, knob 50 is operated to drive threaded shaft 82 toward spool 28 in drum 20 by turning relative to internal thread 84. Ball 72 is thus compressed in bore 80 and engaged (shown) with adjacent detent 78 in lower rim 60 of spool 28.

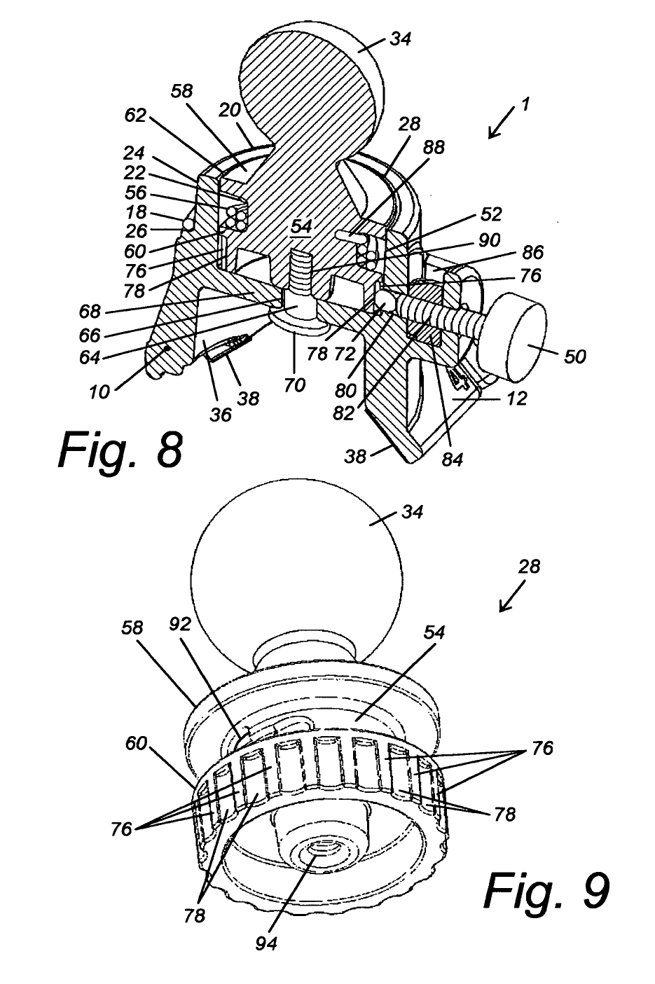

FIG. 8 is a cross-section view of clamping device 10, wherein a bitter end 88 of flex cable 18 is illustrated as being secured relative to spool 28 within interior 52 of drum 20. For example, cable bitter end 88 is coupled into cylindrical core 54 before its working part 29 is wound thereabout and its working end 30 exits from drum 20 through port opening 22. Alternatively, bitter end 88 of cable 18 is coupled into one of upper and lower spool rims 58, 60.

Spindle 64 is illustrated by example and without limitation as a shoulder screw sized to rotate in hole 66 in floor 68 of drum 20 and being threaded 90 into core 54 of spindle 28.

FIG. 9 illustrates one exemplary embodiment of spool 28, wherein cylindrical core 54 includes a receiver 92 for securely receiving cable bitter end 88 for securing flex cable 18 relative to spool 28. Furthermore, spool 28 is formed with a threaded hole 94 for threadedly engaging spindle 64 for securing spool 28 in a relatively rotatable manner within cylindrical hollow interior 52 of drum 20.

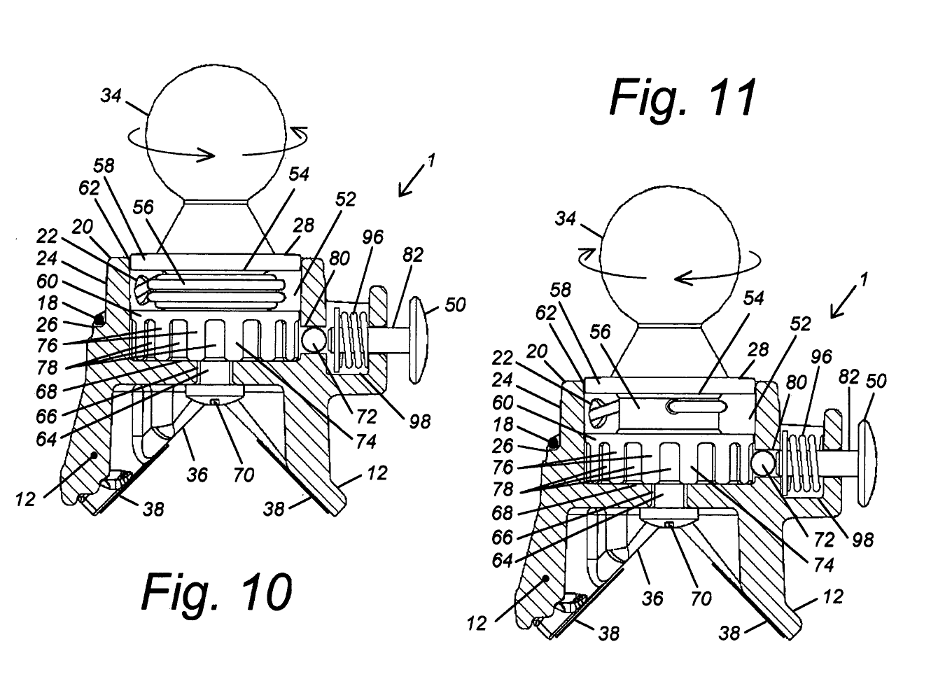

FIG. 10 and FIG. 11 are cross-section views of clamping device 10 illustrating an alternative automatically operated interference mechanism wherein pawl 72 is hinged catch, dog or spherical ball operated by a resilient biasing mechanism. By example and without limitation, pawl 72 is a single sphere movable within bore 80 by pressure of a compression spring 96 which urges spherical ball 72 against lower rim 60 of spool 28, which carries detents 78. Here, detents 78 are illustrated as indentations between circumferential teeth 76. However, detents 78 are optionally as simple as a hole of smaller diameter than spherical ball 72. When the hole, relief or other detent 78 is in line with bore 80, ball 72 falls partially into detent 78 under spring pressure, which fixes spool 28 at that rotational position relative to drum 20. Additional force applied to spool 28 will push spherical ball 72 back into bore 80, compressing spring 96, and allowing spool 28 to rotate to another position within interior 52 of drum 20.

Optionally, knob 50 can be operated to compress spring 96 and relieve pressure biasing spherical ball 72 along bore 80 and into interference contact with detents 78 in lower rim 60 of spool 28. For example, knob 50 is coupled to smooth shaft 82 which is slidable through a pocket 98 having spring 96 compressed therein for biasing spherical ball 72 toward interference with lower rim 60 of spool 28.

FIG. 10 illustrates compression spring 96 in a compressed state which relieves biasing pressure on pawl 72, whereby pawl 72 is disengaged from interference with detents 78 in spool rim 60 and spool 28 may be rotated in interior 52 of drum 20 for extracting flex cable 18.

FIG. 11 illustrates compression spring 96 in an expanded state which applies biasing pressure to pawl 72, whereby pawl 72 is urged along bore 80 into interferential engagement with detents 78 in spool rim 60 and spool 28 is rotationally fixed relative to drum 20 for securing flex cable 18 after being tightened about target platform 16.

According to one embodiment, the interference mechanism is configured as a ratchet in which pawl 72 engages detent 78 in a manner that permits spool 28 to rotate in only one direction, while preventing rotation in the opposite direction. Ratchet interference mechanism may be relieved to permit unwinding of working part 29 from spool core 54 and extraction of flex cable 18 through port opening 22.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1: A universal clamping device, comprising:
a contoured seating surface;
a hollow drum joined to the contoured seating surface and further comprising an outer surface around a hollow interior with an opening communicating therebetween;
a spool rotatable within the hollow interior of the drum adjacent to the opening thereof;
a substantially flexible cable comprising a first end secured relative to the spool and a second end extended outwardly through the opening in the drum;
a means for anchoring the second end of the flexible cable relative to the drum; and
a means for tensioning the flexible cable.

2: The universal clamping device of claim 1, further comprising a flange extended around at least a portion of the drum, the flange comprising the contoured seating surface.

3: The universal clamping device of claim 1, wherein the means for anchoring the second end of the flexible cable relative to the drum further comprises an anchor adjacent to the second end of the flexible cable, and an anchor receiver fixed relative to the drum.

4: The universal clamping device of claim 1, wherein the means for tensioning the flexible cable further comprises means for rotating the spool relative to the drum and the opening thereof.

5: The universal clamping device of claim 1, further comprising means for maintaining tension in the flexible cable.

6: The universal clamping device of claim 1, wherein the means for maintaining tension in the flexible cable further comprises means for fixing the spool in place relative to the drum.

7: The universal clamping device of claim 1, wherein the means for fixing the spool in place relative to the drum further comprises a pawl-and-detent interference mechanism operable between the spool and the drum.

8: The universal clamping device of claim 7, wherein the pawl-and-detent mechanism further comprises one of an automatically operated mechanism, and a manually operated mechanism.

9: A universal clamping device, comprising:
a body comprising an anchor receiver, a flange, and a hollow drum, the flange further comprising a contoured seating surface, and the drum further comprising a substantially cylindrical hollow interior and an outer surface with an opening communicating therebetween;
a substantially cylindrical spool rotatable within the hollow interior of the drum adjacent to the opening thereof and further being rotationally interlockable with the drum;
a substantially flexible cable comprising a first end fixed to the spool and a second end comprising an anchor with a length of working part extended therebetween, the length of working part windable about the spool and further being extensible and retractable through the opening in the body, and the anchor being receivable by the anchor receiver of the body;
and a mount projected above the body.

10: The universal clamping device of claim 9, wherein the flange further comprises a plurality of cable guide features formed thereinto.

11: The universal clamping device of claim 9, wherein the drum further comprises an opening into the cylindrical interior thereof; and the spool is further sized to slip fit into cylindrical hollow interior of drum through the opening thereinto.

12: The universal clamping device of claim 11, wherein the spool further comprises substantially round upper and lower rims with a substantially cylindrical core extended therebetween, and wherein the upper rim further comprises the mount projected therefrom.

13: The universal clamping device of claim 9, further comprising an interference mechanism operational between the spool and the drum.

14: The universal clamping device of claim 13, wherein the interference mechanism further comprises a pawl-and-detent mechanism.

15: The universal clamping device of claim 14, wherein the pawl-and-detent mechanism further comprises one of an automatically operated mechanism, and a manually operated mechanism.

16: A method for clamping, the method comprising:
seating a contoured seating surface against a surface of a target platform;
through an opening into a hollow interior of a drum joined to the contoured seating surface, extracting at least a portion of a working part of a substantially flexible cable nominally wound about a spool rotatable within the hollow interior of the drum adjacent to the opening thereof;
wrapping the working part of the cable about at least a portion of the target platform;
anchoring the flexible cable relative to the seating surface and the drum joined thereto;
tensioning the flexible cable; and
at least temporarily maintaining tension in the flexible cable.

17: The method of claim 18, further comprising securing a first end of the cable relative to the spool; and
wherein tensioning the flexible cable further comprises rotating the spool relative to the interior of the drum.

18: The method of claim 17, further comprising leading the cable along a guide ramp structured about the drum between the opening into the hollow interior thereof and the contoured seating surface.

19: The method of claim 17, further comprising wrapping the cable about one of the drum and a flange comprising the contoured seating surface.

20: The method of claim 19, wherein wrapping the cable about one of the drum and a flange comprising the contoured seating surface further comprises winding the cable through one or more cable guide features.
